(19) United States
(12) Patent Application Publication
(10) Pub. No.: US 2014/0321179 A1
(43) Pub. Date: Oct. 30, 2014

(54) Electrical Circuit Synchronisation

(71) Applicant: CONTROL TECHNIQUES LIMITED, Newtown (GB)

(72) Inventor: Simon David Hart, Welshpool (GB)

(73) Assignee: CONTROL TECHNIQUES LIMITED, Newtown (GB)

(21) Appl. No.: 14/264,649

(22) Filed: Apr. 29, 2014

(30) Foreign Application Priority Data
Apr. 29, 2013 (GB) 1307684.9

(51) Int. Cl. H02M 7/5387

(52) U.S. Cl. CPC H02M 7/53871
USPC 363/132

(57) ABSTRACT

A method, apparatus, computer readable medium, and system for synchronising a power source with a three-phase electricity grid for the power source to supply electricity to the electricity grid is disclosed. The method comprises operating a first switching unit to disconnect a power source from an interfacing circuit. The interfacing circuit comprises a DC-to-AC converter arranged between the power source and a three-phase electricity grid for converting a DC voltage received from the power source to a three-phase AC voltage for supplying the electricity grid, an electrical storage unit connected across the DC-to-AC converter, and a resistance which is selectably connectable in parallel with the electrical storage unit across the DC-to-AC converter, operating a second switching unit to connect the electricity grid to the interfacing circuit, wherein the electrical storage unit is electrically coupled to the electricity grid through the DC-to-AC converter. The method further comprises connecting the resistance to and disconnecting the resistance from the electricity grid through the DC-to-AC converter when the second switching unit is connecting the electricity grid to the interfacing circuit. In addition, the method comprises monitoring one or more electrical characteristics of the interfacing circuit in accordance with the connection and disconnection of the resistance. Furthermore, the method comprises determining one or more electrical characteristics of the three-phase electricity grid in accordance with the monitored electrical characteristics of the interfacing circuit.

### CROSS-REFERENCE TO RELATED APPLICATION

This application claims the benefit and priority of Great Britain Patent Application No. 1307684.9 filed Apr. 29, 2013. The entire disclosure of the above application is incorporated herein by reference.

### FIELD OF INVENTION

This disclosure relates to supply of electrical energy to an electricity grid. More specifically, but not exclusively, a method for determining electrical characteristics of an electricity grid prior to supplying electricity to an electricity grid is disclosed.

### BACKGROUND TO THE INVENTION

Energy production at remote locations has been common for many years via use of oil generators and such like. More recently, renewable energy resources, such as photovoltaic cells or wind farms, have become more popular, in part due to their increased efficiency and reduced cost. Due to the ‘free’ energy produced by renewable energy resources it is becoming more common for renewable energy sources to be used as a primary source of power, not only at remote locations, but for many different applications.

The nature of renewable energy resources means that power is not simply generated when required, as it can be with oil-based generators, but when the source of the power is present. For example, wind farms generate power when there is wind. Consequently, it is becoming common for owners of renewable energy sources, that may use the energy source primarily for powering their own equipment or buildings, to sell some of the generated electricity back to the grid.

In order for electricity to be input into the electricity grid it is necessary to control the characteristics of the power source to minimise the disruption of the electricity supply to the grid. It is common to provide circuitry for monitoring characteristics of an electricity grid, such as magnitude, frequency, and phase characteristics, so that the characteristics of the supply can be adjusted to control the amount of power being put into the grid with minimal disturbance. It is particularly important to know the characteristics of the grid as soon as electricity is supplied so that the initial supply of electricity does not cause a significant disturbance to the grid. Known techniques for determining such characteristics prior to supplying electricity to the grid require use of complex circuitry for monitoring the electrical characteristics of the grid, which is expensive and undesirable.

### SUMMARY OF INVENTION

In accordance with an aspect of the invention there is provided a method for synchronising a power source with a three-phase electricity grid for the power source to supply electricity to the electricity grid. The method comprises operating a first switching unit to disconnect a power source from an interfacing circuit. The interfacing circuit comprises a DC-to-AC converter arranged between the power source and a three-phase electricity grid for converting a DC voltage received from the power source to a three-phase AC voltage for supplying the electricity grid. The interfacing circuit comprises an electrical storage unit connected across the DC-to-AC converter. The interfacing circuit also comprises a resistance which is selectably connectable in parallel with the electrical storage unit across the DC-to-AC converter. The method further comprises operating a second switching unit to connect the electricity grid to the interfacing circuit, wherein the electrical storage unit is electrically coupled to the electricity grid through the DC-to-AC converter. The method also comprises connecting the resistance to and disconnecting the resistance from the electricity grid through the DC-to-AC converter when the second switching unit is connecting the electricity grid to the interfacing circuit. In addition, the method comprises monitoring one or more electrical characteristics of the interfacing circuit in accordance with the connection and disconnection of the resistance. The method also comprises determining one or more electrical characteristics of the three-phase electricity grid in accordance with the monitored electrical characteristics of the interfacing circuit.

An electrical characteristic of the one or more electrical characteristics of the interfacing circuit may be a voltage across the electrical storage unit. An electrical characteristic of the one or more electrical characteristics of the electricity grid may be a peak voltage of the electricity grid. The peak voltage of the electricity grid may be determined by detecting stabilisation of the voltage across the electrical storage unit after the resistance is disconnected from the electricity grid.

The stabilisation voltage may be the peak voltage between two phases of the three-phase electricity grid.

The method may further comprise repeatedly connecting and disconnecting the resistance and determining the peak voltage when the resistance is disconnected. An electrical characteristic of the one or more electrical characteristics of the electricity grid may be a frequency of the electricity grid. The frequency of the electricity grid may be determined in accordance with a time between determined peak voltages.

A period for which the resistance is repeatedly connected and disconnected may be increased until a level sufficient for detection of the peak voltage is identified.

The method may further comprise connecting and disconnecting the resistance at half intervals between the previous repeated connection and disconnection of the resistance. The frequency of the electricity grid may be determined to be double the previously determined frequency if one or more new peak voltages are detected.

An electrical characteristic of the one or more electrical characteristics of the electricity grid may be a phase orientation of the electricity grid. An electrical characteristic of the one or more electrical characteristics of the interfacing circuit may be a current of the interfacing circuit. The phase orientation of the electricity grid may be determined from two or three of the phases determinable from the current.

The method may further comprise charging the electrical storage unit using the power supply prior to operating the first switching unit to disconnect the power supply. The method may also further comprise operating the second switching unit to connect the electricity grid to the interfacing circuit.

The method may further comprise synchronising electrical characteristics of the power supply with the determined electrical characteristics of the electricity grid.

The DC-to-AC converter may be an inverter. The inverter may be inactive when one or more of the power supply or electricity grid is disconnected from the interfacing circuit. The electrical storage device may be a capacitor.

The resistance may comprise a resistive unit and a switch. Toggling the switch may connect and disconnect the resistive unit from being connected across the electrical storage unit.

According to another aspect of the invention apparatus is provided for synchronising a power source with a three-phase electricity grid for the power source to supply electricity to the electricity grid. The apparatus may comprise a processor arranged to perform any appropriate method disclosed herein.

According to yet another aspect of the invention a computer readable medium is provided that is operable in use to instruct a computer to perform any method disclosed herein.

According to a further aspect of the invention a system for use in supplying electricity from a power source to a three-phase electricity grid is provided. The system comprises an interfacing circuit. The interfacing circuit comprises a DC-to-AC converter arranged between a power source and a three-phase electricity grid for converting a DC voltage received from the power source to a three-phase AC voltage for supplying the electricity grid, An electrical storage unit connected across the DC-to-AC converter, and a resistance which is selectably connectable in parallel with the electrical storage unit across the DC-to-AC converter. The apparatus further comprises a first switching unit arranged to disconnect the power source from the interfacing circuit, and a second switching unit arranged to connect the electricity grid to the interfacing circuit. The electrical storage unit is electrically coupled to the three-phase electricity grid through the DC-to-AC converter. The apparatus also comprises a controller arranged to perform any method disclosed herein.

According to another aspect of the invention a method for synchronising a power source with a three-phase electricity grid for the power source to supply electricity to the electricity grid is provided. The method is arranged for operation with an interfacing circuit comprising a DC-to-AC converter arranged between a power source and a three-phase electricity grid for converting a DC voltage received from the power source to a three-phase AC voltage for supplying the electricity grid, an electrical storage unit connected across the DC-to-AC converter, and a resistance which is selectably connectable in parallel with the electrical storage unit across the DC-to-AC converter. Furthermore, the method is primarily arranged for operation when the interfacing circuit is disconnected from the power source and connected to the three-phase electricity grid. The method comprises connecting the resistance to and disconnecting the resistance from the electricity grid through the DC-to-AC converter when the second switching unit is connecting the electricity grid to the interfacing circuit. The method also comprises monitoring one or more electrical characteristics of the interfacing circuit in accordance with the connection and disconnection of the resistance. Furthermore, the method comprises determining one or more electrical characteristics of the three-phase electricity grid in accordance with the monitored electrical characteristics of the interfacing circuit. The method may further comprise operating a first switching unit to disconnect the power source from the interfacing circuit prior to connecting and disconnecting the resistance. The method may also comprise operating a second switching unit to connect the electricity grid to the interfacing circuit prior to connecting and disconnecting the resistance, and preferably after disconnecting the power source from the interfacing circuit. In operation, the electrical storage unit is electrically coupled to the electricity grid through the DC-to-AC converter;

According to an aspect of the invention electrical characteristics of a power source are synchronised to a grid supply, prior to the power source supplying electrical power to the grid supply, by determining the electrical characteristics of the grid supply by varying a resistance across a capacitance connected to the grid supply and determining the resultant variation in electrical characteristics associated with the capacitor. The capacitance may be connected in parallel with the grid. A switchable resistance may be selectively connectable across the capacitance in order to vary the voltage across the capacitance. The capacitance may be connected to the grid via an inactive inverter.

The power source may be connected to the grid supply via the capacitor and inverter arrangement, or the interface circuit as it is also called, to supply electricity to the grid once the electrical characteristics of the grid have been determined and the electrical characteristics of the power source are synchronised with the electrical characteristics of the grid.

### BRIEF DESCRIPTION OF THE DRAWINGS

Exemplary embodiments of the invention shall now be described with reference to the drawings in which:

FIG. 1 illustrates an output circuit for supplying electricity from a power source to a grid;

FIG. 2 shows the three-phase voltage supply of the grid and the DC bus voltage with respect to time when determining a peak voltage of the grid; and

FIG. 3 shows currents supplied by the grid and the DC bus voltage with respect to time when determining a phase orientation of current in the grid.

Throughout the description and the drawings, like reference numerals refer to like parts.

### SPECIFIC DESCRIPTION

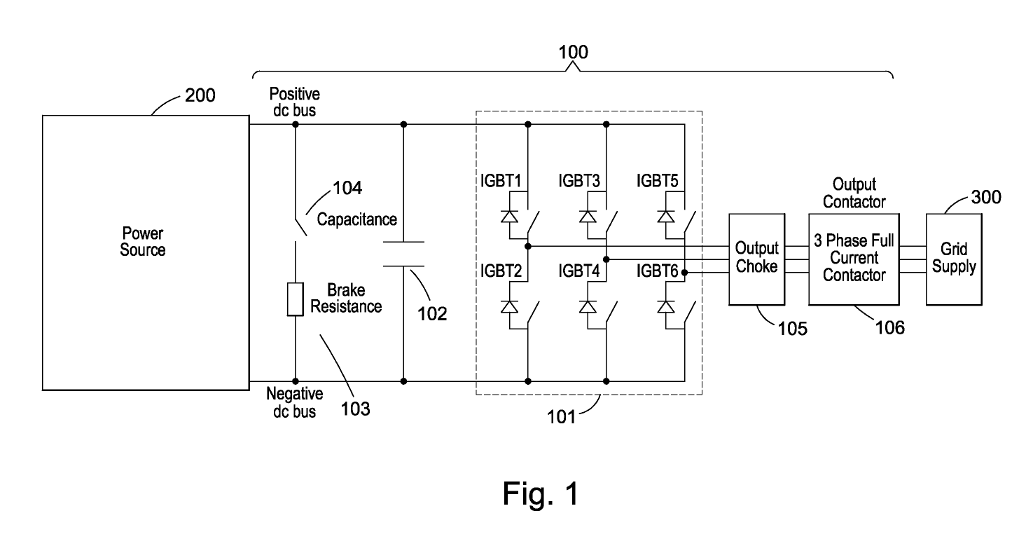

FIG. 1 illustrates an output circuit 100 for supplying power produced by a power source 200 to an electricity grid or grid supply 300. When the power source 200 produces power that is not being used locally then it is able to ‘sell’ the excess electricity back to the grid. The output circuit 100 provides a connection between the power source 200 and the grid 300 for synchronising the electrical characteristics of the power source 200 to the electrical characteristics of the grid 300 in order to cause minimum disturbance to the grid when electricity is being supplied from the power source 200 to the grid 300. The output circuit 100 shall now be briefly described.

Electricity is supplied from the power source 200 via a positive and a negative DC bus to an inverter 101, which is arranged to convert the DC electricity supply to an AC electricity supply suitable for being supplied to the grid 300. A capacitance 102 is provided between the positive and negative DC bus and across both the power source supply and the inverter 101. The capacitance 102 is arranged to store energy permitting for decoupling of the power source 200 from the grid 300, while also protecting rapid switching of the inverter from the power source. Furthermore, the capacitance energy source permits the phase between the voltage and current to be controlled. A brake resistance 103 is provided in parallel with the capacitance 101 in order to discharge the DC bus at selected points in the supply mains cycle. The brake resistance is provided in series with a switch 104 that allows for the brake resistance to be selectively applied. Hence, the brake resistance 103 is provided in the circuit primarily for this functionality. The inverter 101 supplies a three-phase output to an output choke 105 for smoothing the current before it is supplied to the grid.

The output of the inverter 101 is provided with means for monitoring the electrical characteristics of the electricity being supplied to the grid 300, such as voltage or current detectors. In particular, the current delivered to the grid 300 is measured at the output of the inverter by means of a current sensor (not shown). Furthermore, the DC voltage across the capacitance 102, i.e. between the positive and negative DC buses, is measured inside the output circuit. No other measurements are necessary because the inverter output voltage can be determined from the demand into an inverter modulator (not shown) driving the switching of the inverter.

The monitored characteristics are fed back to a controller (not shown), which can then control various aspects of the power source. In particular, the braking IGBT switch 104 is controlled and the inverter can be controlled when the system is very close to synchronisation. The controller comprises an input communications unit arranged to receive information from the electrical characteristic monitoring units, a processor arranged to process the received information, and a memory arranged to store the received information, information used during the processing and/or results of the processing. An output contactor 106 is then provided to enable the electricity supply from the power source to the grid to be cut-off. The controller is arranged to control the output contactor 106. A contactor (not shown) is also provided in the power source 200 so that the power source can be cut-off from the output circuit.

A new method of synchronisation of the output circuit 100 to the grid 300 shall now be discussed, which is provided by the controller prior to the power source 200 supplying power to the grid 300. The purpose of the synchronisation process is for the output circuit to determine electrical characteristics of the grid in order to minimise disturbance to the grid when electricity is supplied to the grid. In particular, the frequency, phase and voltage peak detection are determined. Characteristics of electricity supplied to the grid from the power source 200 are therefore set to match or closely match the corresponding characteristics of the grid for minimisation of grid disturbance. This pre-supply synchronisation process shall now be described in detail.

Firstly, it is necessary for the capacitance 102 to be pre-charged. The capacitance is charged equal to or above the voltage that would result from rectifying and filtering the grid supply equal to the peak of the AC between two phases. The power source 200 supplies the electricity for pre-charging of the capacitor. At this point, the output contactor 106 is open so that the grid is disconnected and the power source contactor provided at an output of the power source that is connecting the power source 200 to the output circuit 100 is closed. A soft-start resistance (not shown) is provided in series between the power source 200 and the capacitance in order to restrict the current flow supplying the capacitance. Once the capacitance is pre-charged, the power source contactor (not shown) is opened and the output contactor 106 is then closed to connect the output circuit 100 to the grid 300. At this point the synchronisation process can start.

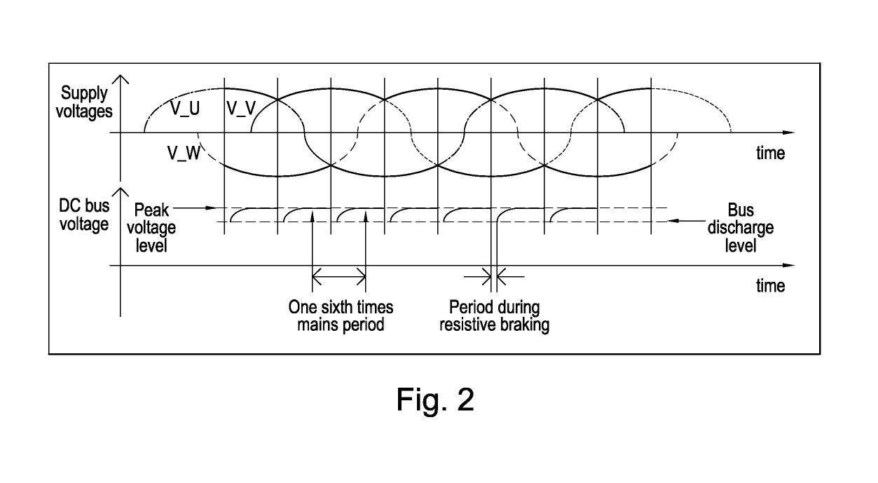

The peak voltage detection is performed utilising the braking resistance 103. In summary, when the braking resistance is connected across the capacitance 102, the voltage across the capacitance is reduced. Consequently, the grid will subsequently charge the capacitance due to the reduction in voltage. While the grid charges the capacitance the charging is monitored. In particular, the slope and peak of the grid voltage can be determined as the grid charges the capacitance 102. Furthermore, from the peak and intervals between peaks the grid voltage level and the frequency of the grid can be determined. The durations and position of these discharging periods is controlled to minimise the disturbance to the grid while still providing all of the required grid information. This operation shall now be described in detail with reference to FIG. 2.

In operation, the dynamic brake 103 is connected across the capacitance 102 by toggling the switch 104 for a short period every 2.5 ms (400 Hz) for a brake period of 50 μs gradually increasing to a maximum of 250 μs until a change in the DC bus level during the braking period is enough to permit the detection of the supply peaks. The levels of the reduction in the voltage of the DC capacitance 102 are set when the system is designed and are related to the resolution of the sensors and the sampling circuits. In practice, the aim is to reduce the energy in the capacitance 102 by just enough to determine the grid information so as to minimise the disturbance to the grid. For example, when on a 600V DC bus with a measurement resolution of a quarter of a volt, 20V is used. The braking resistance is sized so that it is small enough to discharge the DC bus capacitance 102 between the peaks of the grid supply voltages but large enough not to significantly load the supply.

During the synchronisation process the inverter 101 is inactive. However, due to the anti-parallel diodes associated with each of the IGBTs, the positive and negative DC buses are connected to the grid 300. Consequently, current is able to flow from the grid 300 into the output circuit 100 and interact with the capacitance 102, and in turn with the braking resistance 103 as will be discussed. Furthermore, the arrangement of the IGBTs of the inactive inverter 101 act like a diode bridge rectifier, as will be discussed.

Without capacitance 102 and when the inverter 101, acting like a diode bridge rectifier, is connected to the three phase grid supply 300 a rectified wave at six times the supply grid supply frequency is produced. This wave is synchronised with the grid frequency. For example, a 415Vrms supply line to line gives 586V peak and 560V average. When the capacitance 102 is inserted across the inverter 101, the voltage across the capacitance 102 becomes filtered flat at the peak value of the line to line voltage (e.g. 586V). In FIG. 2, the three-phase grid supply is shown at the top, with the DC bus voltage shown, i.e. the filtered wave at the bottom.

If the brake resistance 103 is applied when the rectified wave would have been at its lowest voltage, the capacitor can be discharged to 560V. As the next peak of the grid supply 300 rises the voltage is taken back up to the 586V level. If the brake is applied when the rectifier wave is not at its lowest, the minimum DC capacitance 102 voltage is affected by the grid, which will both result in charging of the capacitance 102 and support the voltage as some grid current will also flow through the brake resistance 103.

In FIG. 2, the three phases (V_U, V_W, V_V) of the grid supply 300 can be seen in the upper graph, while the DC bus variation can be seen in the lower graph. In particular, after the brake resistance 103 connection is removed the voltage slowly increases from the reduced voltage associated with the energy transferred to the brake resistance 103 to the peak voltage level of the grid supply 300. The DC bus voltage flattens out at a point synchronised to the peak of the line to line grid supply The point at which the DC voltage flattens out is determined.

By applying braking pulses with an interval of 400 Hz, as discussed above, which does not match either a 50 Hz or a 60 Hz supply so that the test points will never be synchronised to the mains. Being asynchronous increases the probability of applying the braking pulse when the “rectified wave” (i.e. the wave created on the output of the rectifier when there is no capacitance 102 fitted) is at its lowest. Furthermore, the duration of the braking pulse is also increased over time which in turn increases the amount by which the DC capacitance value can be discharged by. As soon as a difference in voltage of 20V is seen, a peak of the rectified wave can be detected, and therefore the peak of the grid. From then on the brake intervals can start to be moved until the frequency of the grid waves is matched. In FIG. 2, the brake pulse is applied at the minimum of the rectified wave and the re-charge voltage is measured to detect the peak voltage.

The process above is repeated until at least 50 peak voltages have been detected. The frequency, peak voltage and phase are able to be deduced by the controller after 50 peaks have been detected. 50 is selected in order to balance a robustness against noise with respect to the time taken to obtain the samples. The controller calculates the integer sub-multiple of the minimum time between peaks which produces a frequency between 40 Hz and 70 Hz. In practice, the times of the voltage peaks are known and the frequency and phase of the rectified wave, which is six times the frequency of the grid supply, is known. However, a check needs to be carried out to determine that the determined frequency is not half the actual frequency just in case the measurements carried out only recognise half the grid peaks. This is done by performing the testing at twice the frequency, i.e. using braking periods half way between the first set of braking periods. If no further grid peaks are found it is determined that the detected frequency is correct. If additional peaks are detected and it is determined that the previous frequency was in fact half the actual frequency, then the originally detected frequency is doubled.

In order to test the results, the braking periods are triggered at the determined frequency of the grid 300 so that the period of the brake pulses completes, i.e. the brake resistance 103 is disconnected, at least 100 μs before the deduced peak of the supply mains.

Measurements of the DC bus voltage level are taken across the capacitance 102 by a voltage measurement unit (not shown) that is associated with the controller. The measurements are taken at 10 μs intervals for a measurement period of 250 μs immediately after the braking period has been completed. The samples from the measurement periods are then analysed by the controller to locate the “peak of the supply mains sample” where the bus voltage rises to a peak level and remains there for over 50 μs. A time stamp is stored for each of these detected “peaks of the mains samples”. In FIG. 2, it can be seen that the DC bus voltage increases until it reaches a peak voltage level, which is the supply voltage level. It is assumed that there is little loss across the choke 105 and the diodes of the inverter 101, which is a valid assumption as very little current flows once the DC capacitance 102 has been charged to the peak value. The level of the charged DC capacitance 102 allows for the line to line grid voltage to be calculated. For example, 415Vrms line to line gives 586V peak and 560V average.

FIG. 2 shows an ideal situation where the grid supply is balanced. In reality this may not be the case. An unbalanced supply may result in missing detected “peaks of the mains supply”. The worst case situation results in a block of two peaks missing in every six. However, this is still enough information for the peak voltage and frequency to be obtained.

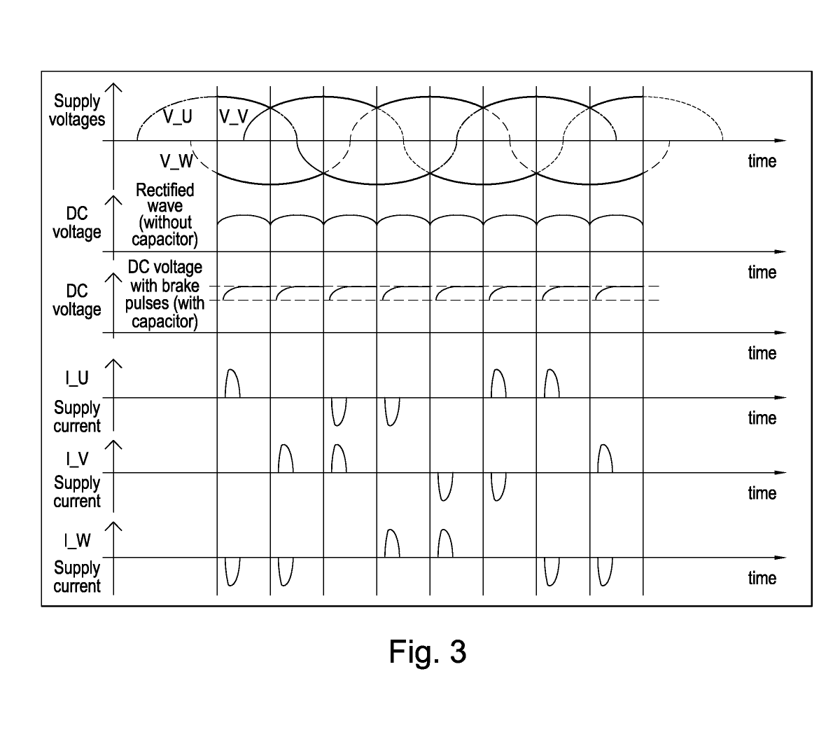

At this point the frequency, peak level, and phase (directly derivable from the frequency) of the grid are known but the phase orientation or order is not known. The method for phase orientation detection is set-out below with reference to FIG. 3.

As can be seen from FIG. 1, when current passes through the output choke 105 to the positive and negative DC buses, the current being measured is the current of two of the three phases. By detecting which of two of three phases are present, the overall phase orientation of the grid can be determined using known techniques. For example, with reference to FIG. 3, which shows plots for the three phases of the three-phase grid: U, V and W. If the W phase currents (bottom plot) were not detected, the phase order can still be determined from the pattern of the U and V phases alone. If we consider only the positive current peaks, the pattern would be U, V, V, none, none, U, U, V. As the V phase positive peak in current occurs after the U phase so the W phase must occur after the V phase as the grid is a balanced three phase system. The phase rotation order in this example is U, V, W and we can synchronise the system accordingly.

FIG. 3 shows an ideal situation where the grid supply is balanced. An unbalanced supply will result in current peaks of differing maximum level. The worst case situation results in a block of two peaks missing in every six where the missing peaks will be from the same phase. In the system of FIG. 1 disclosed herein, only the detection of two phases (four out of six current peaks) is required to correctly deduce the phase sequence.

Once the peak voltage, frequency, phase orientation are determined by the controller, the power source 200 can then be connected for supply of electricity to the grid. At this point the peak voltage, frequency and phase of the power source 200 can be set to match those of the grid 300 in order to minimise disturbance to the grid 300 once supplying electricity.

Before switching the inverter with a voltage demand equal to the grid, the power source 200 needs to be connected. Before connecting the power source 200, the frequency and phase errors must be below +/−1% (<0.5 Hz and 3.6° respectively) and the voltage peak error must be below +/−5% (<20Vrms on a 415Vrms supply). If these conditions are not met there may be excessive current flow due to the voltage error across the output choke when the inverter is activated. These are typical limits and the actual limits will depend on the complete system.

Any current measured during this process is used to provide an error signal as there should be no current flowing across the output choke/transformer once the synchronisation has completed. Known methods can then be used to correct for the detected error in the synchronisation process.

The various methods described above may be implemented by a computer program. The computer program may include computer code arranged to instruct a computer to perform the functions of one or more of the various methods described above. The computer program and/or the code for performing such methods may be provided to an apparatus, such as a computer, on a computer readable medium or computer program product. The computer readable medium could be, for example, an electronic, magnetic, optical, electromagnetic, infrared, or semiconductor system, or a propagation medium for data transmission, for example for downloading the code over the Internet. Alternatively, the computer readable medium could take the form of a physical computer readable medium such as semiconductor or solid state memory, magnetic tape, a removable computer diskette, a random access memory (RAM), a read-only memory (ROM), a rigid magnetic disc, and an optical disk, such as a CD-ROM, CD-RAN or DVD.

An apparatus such as a computer may be configured in accordance with such code to perform one or more processes in accordance with the various methods discussed herein. Such an apparatus may take the form of a data processing system. Such a data processing system may be a distributed system. For example, such a data processing system may be distributed across a network.

1. A method for synchronising a power source with a three-phase electricity grid for the power source to supply electricity to the electricity grid, the method comprising:
operating a first switching unit to disconnect a power source from an interfacing circuit, the interfacing circuit comprising:
a DC-to-AC converter arranged between the power source and a three-phase electricity grid for converting a DC voltage received from the power source to a three-phase AC voltage for supplying the electricity grid;
an electrical storage unit connected across the DC-to-AC converter; and
a resistance which is selectably connectable in parallel with the electrical storage unit across the DC-to-AC converter;
operating a second switching unit to connect the electricity grid to the interfacing circuit, wherein the electrical storage unit is electrically coupled to the electricity grid through the DC-to-AC converter;
connecting the resistance to and disconnecting the resistance from the electricity grid through the DC-to-AC converter when the second switching unit is connecting the electricity grid to the interfacing circuit;
monitoring one or more electrical characteristics of the interfacing circuit in accordance with the connection and disconnection of the resistance; and
determining one or more electrical characteristics of the three-phase electricity grid in accordance with the monitored electrical characteristics of the interfacing circuit.

2. The method according to claim 1, wherein an electrical characteristic of the one or more electrical characteristics of the interfacing circuit is a voltage across the electrical storage unit and an electrical characteristic of the one or more electrical characteristics of the electricity grid is a peak voltage of the electricity grid, wherein the peak voltage of the electricity grid is determined by detecting stabilisation of the voltage across the electrical storage unit after the resistance is disconnected from the electricity grid.

3. The method according to claim 2, wherein the stabilisation voltage is the peak voltage between two phases of the three-phase electricity grid.

4. The method according to claim 2, further comprising:
repeatedly connecting and disconnecting the resistance and determining the peak voltage when the resistance is disconnected, wherein an electrical characteristic of the one or more electrical characteristics of the electricity grid is a frequency of the electricity grid and the frequency of the electricity grid is determined in accordance with a time between determined peak voltages.

5. The method according to claim 4, wherein a period for which the resistance is repeatedly connected and disconnected is increased until a level sufficient for detection of the peak voltage is identified.

6. The method according to claim 4, further comprising connecting and disconnecting the resistance at half intervals between the previous repeated connection and disconnection of the resistance, wherein the frequency of the electricity grid is determined to be double the previously determined frequency if one or more new peak voltages are detected.

7. The method according to claim 1, wherein an electrical characteristic of the one or more electrical characteristics of the electricity grid is a phase orientation of the electricity grid and an electrical characteristic of the one or more electrical characteristics of the interfacing circuit is a current of the interfacing circuit, wherein the phase orientation of the electricity grid is determined from two or three of the phases determinable from the current.

8. The method according to claim 1, further comprising charging the electrical storage unit using the power supply prior to operating the first switching unit to disconnect the power supply and operating the second switching unit to connect the electricity grid to the interfacing circuit.

9. The method according to claim 1, further comprising synchronising electrical characteristics of the power supply with the determined electrical characteristics of the electricity grid.

10. The method according to claim 1, wherein the DC-to-AC converter is an inverter.

11. The method according to claim 10, wherein the inverter is inactive when one or more of the power supply or electricity grid is disconnected from the interfacing circuit.

12. The method according to claim 1, wherein the electrical storage device is a capacitor.

13. The method according to claim 1, wherein the resistance comprises a resistive unit and a switch, wherein toggling the switch connects and disconnects the resistive unit from being connected across the electrical storage unit.

14. Apparatus for synchronising a power source with a three-phase electricity grid for the power source to supply electricity to the electricity grid, the apparatus comprising:
a processor arranged to perform the method of claim 1.

15. A computer readable medium operable in use to instruct a computer to perform the method of claim 1.

16. A system for use in supplying electricity from a power source to a three-phase electricity grid, the system comprising:
an interfacing circuit comprising:
a DC-to-AC converter arranged between a power source and a three-phase electricity grid for converting a DC voltage received from the power source to a three-phase AC voltage for supplying the electricity grid;
an electrical storage unit connected across the DC-to-AC converter; and
a resistance which is selectably connectable in parallel with the electrical storage unit across the DC-to-AC converter;
a first switching unit arranged to disconnect the power source from the interfacing circuit;
a second switching unit arranged to connect the electricity grid to the interfacing circuit, wherein the electrical storage unit is electrically coupled to the three-phase electricity grid through the DC-to-AC converter; and
a controller arranged to perform the method of claim 1.
